(19) United States
(12) Patent Application Publication
(10) Pub. No.: US 2008/0161480 A1
(43) Pub. Date: Jul. 3, 2008

(54) WATERBORNE COATING COMPOSITIONS

(75) Inventor: Pillai T. Perumal, Avon Lake, OH (US)

Correspondence Address: THE SHERWIN-WILLIAMS COMPANY, 101 PROSPECT AVENUE N.W., 1100 MIDLAND BLDG. - LEGAL DEPARTMENT, CLEVELAND, OH, 44115-1075, US

(73) Assignee: THE SHERWIN-WILLIAMS COMPANY, Cleveland, OH (US)

(21) Appl. No.: 11/950,804

(22) Filed: Dec. 5, 2007

Related U.S. Application Data
(60) Provisional application No. 60/869,011, filed on Dec. 7, 2006.

(51) Int. Cl. C08L 67/00; B05D 3/00

(52) U.S. Cl. 524/539; 524/599; 427/372.2

(57) ABSTRACT

Water reducible graft polymers and coatings, including aerosol coatings, are described. The graft copolymers are useful for application to plastic and other substrates.

This application claims the benefit of U.S. provisional patent application No. 60/869,011 filed on Dec. 7, 2006, the entirety of which is hereby incorporated by reference.

Plastics, such as thermoplastic polyolefins (TPO) and reaction injected molding urethane (RIM), are frequently utilized as parts in the automotive industry and in other applications because of their relatively low cost, moldability, and superior resistance to solvents and moisture.

The plastics are, however, frequently difficult to paint due to one or more of their physical and chemical characteristics, such as their relatively non-polar surface (especially for polyolefins like polypropylene, polyethylene, ethylene propylene diene copolymer, etc.) and the surface tension, roughness and flexibility of the cured plastic itself. These difficulties can be especially true when using water dispersible coatings since it is often difficult for a relatively high surface tension water dispersible coating to adequately wet a plastic substrate like a polyolefin. Sometimes the plastic substrates are treated with a flame, corona or gas plasma treatment, or coated with a tie coat or adhesion promoter but this adds an additional manufacturing step. Some tie coats and adhesion promoters utilize halogenated, especially chlorinated, polyolefins, but the halogenated polyolefins are relatively expensive and are costly if used in large amounts. Additionally, the halogenated polyolefins are often relatively high molecular weight polymers, and they often are relatively insoluble in many non-aromatic solvents. These characteristics can make it difficult to minimize VOC (Volatile Organic Content) of the coatings when incorporating halogenated polyolyfins.

In one useful embodiment, the present invention relates to water reducible coating compositions, which can be applied to a variety of substrates, including plastic substrates, by any of a variety of methods such as brushing, rolling, spraying, curtain coating, or other application method, including aerosol spray from a sealed and pressurized container. Many conventional paint compositions, and particularly aerosol paints, adhere poorly to many plastic substrates. The coatings of this invention, however, can be applied to a variety of substrates including wood, metal, and fabric and will also adhere well to many hard to coat substrates such as plastics, including polyolefins, polyphenylene oxide, PVC, BMC, SMC, polystyrene, etc. The coatings of this invention utilize a water reducible polymer readily obtained by the graft copolymerization of a halogenated, normally chlorinated, polyolefin and unsaturated monomers.

For many application methods, the water reducible versions of the coatings of this invention can be applied at relatively low levels of volatile organic compounds (VOC). As used herein, the term VOC shall mean a volatile organic solvent capable of vaporizing at atmospheric pressure and a temperature in a range from about 35° F. to about 140° F. For applications where it is desirable to minimize the amount of organic solvent present it is useful to prepare the coatings of this invention wherein the organic solvent is present at a level to provide a VOC of less than 150 grams per liter. Many of the coatings of this invention can be formulated to have a convenient application viscosity of less than about 100 KU (Krebs Units), or even less than about 90 KU at such a low VOC level. For many of the coatings within this invention it is convenient to obtain these relatively low viscosities by incorporating the chlorinated polyolefin (CPO) at a level of about 15% or less and sometimes about 10% or less of the total weight solids of the graft copolymer.

In one aspect, this invention relates to a polymer comprising the reaction product obtained by graft copolymerizing from about 1 to about 20% by weight of an unsaturated acid or anhydride and from about 61 to about 98 percent by weight of at least one other unsaturated monomer copolymerizable with the acid or anhydride with about 1 to about 19% by weight of at least one chlorinated polyolefin, wherein the percentages are based upon the total combined weight of the chlorinated polyolefin and all unsaturated monomers.

In another aspect, this invention relates a polymer comprising the graft polymerization reaction product of:
(i) from about 1 to about 19% by weight of at least one chlorinated polyolefin;
(ii) from about 1 to about 20% by weight of an unsaturated acid or anhydride;
(iii) from about 1 to about 40%, and sometimes 10 to about 40%, styrene;
(iv) from about 21 to 97% by weight of at least one other unsaturated monomer copolymerizable with the unsaturated acid or anhydride;
   wherein the percentages are based upon the total combined weight of the chlorinated polyolefin and all unsaturated monomers.

Another aspect involves the aqueous polymer solutions obtained by the addition of a sufficient amount of a neutralizing agent to provide a stable dispersion of these polymers in water. Another aspect involves coatings which utilize these polymers. Further aspects, features, and advantages of the present invention will become better understood with regard to the following description, examples, appended claims and accompanying drawing.

### DESCRIPTION OF THE DRAWINGS

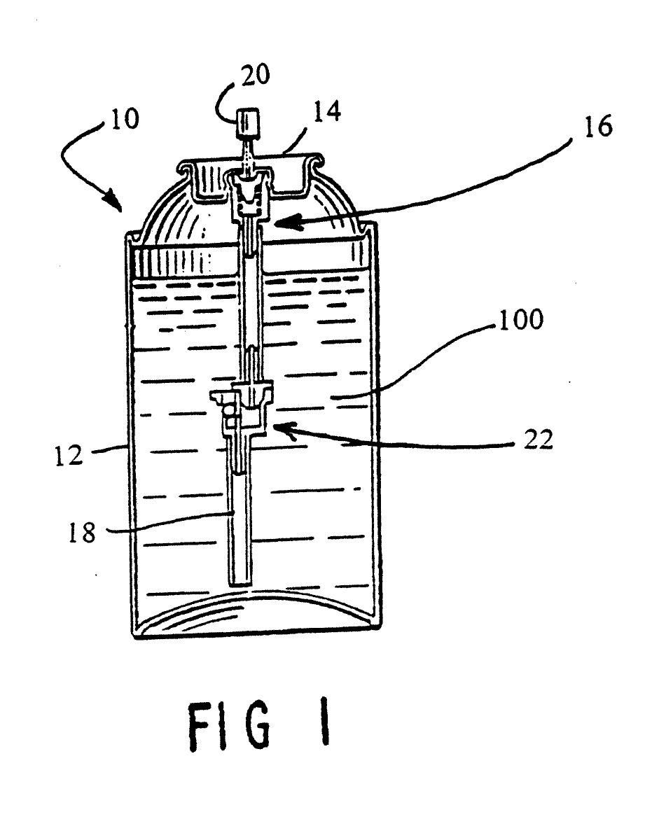

One method of applying the coatings of this invention is by aerosol spray. FIG. 1 shows a schematic of a representative aerosol container charged with an aerosol paint composition prepared in accordance with this invention. In preparing an aerosol paint composition, the water reducible coating of this invention is added to a container, such as container 10 shown in FIG. 1, and then the propellant is added to form the aerosol paint composition.

Referring now to FIG. 1, the container 10 comprises a can 12, to which a valve cup 14 is secured. A valve assembly 16 with a dip tube 18 connected thereto is secured to the valve cup 14. The dip tube 18 extends into the interior of the can 12 and is in contact with the aerosol paint composition, which is designated by the numeral 100. The can 12 may typically be composed of aluminum or tin plated steel. If desired the can may be lined or coated to minimize corrosion while in contact with the water reducible coatings. The valve cup 14 may be sealed to the can 12 and the propellant charged through the valve assembly 16, or the can 12 may be charged with the propellant under the valve cup 14, and then the valve cup 14 sealed to the can 12. An actuator 20 is then connected to the valve assembly 16.

Various valves, dip tubes and actuators may be used to spray the aerosol paint composition. For many applications, the dip tube 18 is a standard dip tube having a diameter of about 0.147 inches. The valve assembly 16 may be either a “female” aerosol valve or a “male” aerosol valve. Examples of “female” aerosol valves that may be used in the present invention are disclosed in U.S. Pat. Nos. 3,033,473; 3,061,203; 3,074,601; 3,209,960; and 5,027,985. Examples of “male” aerosol valves that may be used in the present invention are disclosed in U.S. Pat. Nos. 2,631,814, and 4,572,406. For some applications, the valve assembly 16 is a “female” valve with a spray controller 22 having a construction as disclosed in U.S. Pat. No. 4,572,406, which is hereby incorporated by reference. The spray controller 22 permits the aerosol paint composition 100 to be dispensed when the container 10 is inverted.

### Water Reducible Coating Compositions and Components

### 1. Graft Copolymers of Unsaturated Monomers with Chlorinated Polyolefins

The polymers of this invention are conveniently obtained by the graft polymerization of an unsaturated acid or anhydride and at least one other unsaturated monomer copolymerizable with the unsaturated acid or anhydride onto at least one halogenated polyolefin, such as a chlorinated polyolefin.

Chlorinated polyolefins (CPOs) are well known in the art and include, representatively, chlorinated polypropylene, chlorinated polybutene, chlorinated polyethylene etc. The CPOs can be prepared by any method known in the art. For example, the CPO can be prepared by dissolving the polyolefin in a suitable solvent and then blowing chlorine gas into the solution, usually in the presence of a radical catalyst. Typically, for many commercial products, chlorination levels of at least about 10% by weight, and frequently 15 to about 50% by weight are achieved. The CPOs can also have some acid functionality, generally incorporated by reaction of an acid or anhydride onto the polyolefin. For some applications of this invention, it can be useful to utilize CPOs having a number average molecular weight less than about 50,000. In other applications, it can be useful to utilize a CPO having a number average molecular weight less than about 30,000. Number average molecular weight is typically determined relative to a polystyrene standard.

The graft copolymers useful in this invention are conveniently prepared by admixing the ethylenically unsaturated monomers and CPO in the presence of a polymerization initiator such as t-butyl peroxybenzoate, benzoyl peroxide, di-tert-butyl peroxide and/or azobisisobutyronitrile.

Suitable monomers for copolymerization with the CPO include (meth)acrylic monomers and vinyl aromatic monomers. Representative vinyl aromatic monomers include styrene, alpha methyl styrene or other lower alkyl styrene, chlorostyrene, vinyl toluene, vinyl naphthalene, and divinyl benzene. For some applications of this invention, it is useful to provide at least 1%, and sometimes at least 10%, and sometimes between 10 and 40%, of the total amount of CPO and copolymerizable monomer as a vinyl aromatic monomer such as styrene.

Representative copolymerizable acrylic monomers include any compounds having acrylic functionality, such as alkyl (meth)acrylates, (meth)acrylic acids, acrylamides and acrylonitrile. Typically, the alkyl (meth)acrylate monomers (commonly referred to as “alkyl esters of (meth)acrylic acid”) will have an alkyl ester portion containing from 1 to about 12, and generally about 1 to 8, carbon atoms per molecule. Suitable alkyl (meth)acrylate monomers include, for example, methyl (meth)acrylate, ethyl (meth)acrylate, butyl (meth)acrylate, propyl (meth)acrylate, 2-ethyl hexyl (meth)acrylate, cyclohexyl (meth)acrylate, decyl (meth)acrylate, isodecyl (meth)acrylate, benzyl (meth)acrylate, isobornyl (meth)acrylate, neopentyl (meth)acrylate, 1-adamatyl methacrylate and various reaction products such as butyl, phenyl, and cresyl glycidyl ethers reacted with (meth)acrylic acid, hydroxyl alkyl (meth)acrylates, such as hydroxyethyl and hydroxypropyl (meth)acrylates, and amino (meth)acrylates. The term “(meth)acrylate” is meant to include acrylates and methacrylates. Other copolymerizable unsaturated monomers, including vinyl compounds such as vinyl acetate, or vinyl versatate can also be utilized. Monomers capable of latent crosslinking such as diacetone acrylamide can also be used.

It is useful to incorporate sufficient acid functionality into the graft copolymer to provide an acid value high enough to provide water solubility when neutralized with a neutralizing agent. Suitable unsaturated acids and anhydrides which could be copolymerized into the graft copolymers include the unsaturated derivatives of inorganic acids such as AMPS (acrylimidomethylpropane sulfonic acid, available from Lubrizol), and phosphoric acid derivatives such as hydroxy ethyl methacrylate phosphate or the phosphate ester of 3-hydroxy propyl methacrylate, as well as unsaturated organic acids such as (meth)acrylic acid, ethacrylic acid, alpha-chloroacrylic acid, alpha-cyanoacrylic acid, crotonic acid, beta-acryloxy propionic acid, beta-styryl acrylic acid, maleic anhydride, and the unsaturated acids and anhydrides taught in U.S. Pat. Nos. 5,863,998, 5,633,327, 5,444,122, and 5,405,973, the teachings of which are hereby incorporated by reference. For some applications it is useful to provide a final acid value of at least about 10, or for some applications at least about 20, or, for some applications, at least about 40, or, for some applications, at least about 60 for the graft copolymer.

The acid functional graft copolymers can easily be made water dispersible, by admixing the polymers with an amount of a neutralizing agent, such as an amine or other base, sufficient to provide the desired degree of water dispersiblity. Representative useful amines include ammonia, and alkyl or alkanol amines such as dimethyl benzyl amine, dimethylethanol amine, diisopropyl amine, and triethyl amine. It is only necessary to incorporate sufficient base to provide the desired level of water miscibility and stability. For some water reducible applications, it will be useful to add enough base to theoretically neutralize at least about 40% of the acid groups of the polymer.

The graft copolymers can be conveniently prepared by admixing the monomers and the CPO in the presence of a suitable initiator under suitable graft copolymerization conditions. It is frequently useful to incorporate the CPO into the reaction mixture as a solution in a suitable solvent such as toluene or xylene. The reaction temperatures will typically be at least about 240° F., and may range up to about 350° F. It is often useful to gradually admix the reactants into a heated solvent solution. For some production of the graft copolymer, it can be useful to prepare a premix of a solvent solution of the CPO and some, or all, of any unsaturated vinyl aromatic monomers to ensure solubility of the CPO and to minimize any requirement for solvent in the reaction mixture. Additionally, for some embodiments of this invention it is desirable to minimize the level of CPO in the final graft copolymer to minimize final viscosity and reduce the requirement for additional solvents. For many low VOC formulations, it can be useful to incorporate the CPO at a level of 1 to about 15%, 1 to about 10%, 1 to about 6%, or even 1 to about 4%, of the total combined weight of the chlorinated polyolefin and all copolymerizable monomers in the graft copolymer.

The graft copolymers of this invention are useful in a variety of applications, including their use as components of coating compositions. The water dispersible paint compositions of the present invention may include other optional ingredients, such as other water-reducible polymers, crosslinkers, pigments, surfactants and dispersants, rheology modifiers, anti-skinning agents, drying agents, light stabilizers and ultraviolet light absorbers, and solvents.

### 2. Water-Reducible Film-Forming Polymers

If desired, other water reducible film forming polymers such as latex polymers and water reducible acrylics, polyesters (including alkyds), and polyurethanes (including polyurethane dispersions) can optionally be combined with the graft copolymers in water reducible coating formulations. Typically, these additional polymers, if incorporated, may be present at a level of about 1 to about 99% by weight solids of the combined weight of the graft copolymer and the additional polymer. For some applications it is useful to incorporate from about 10 to about 60% by weight solids of the combined weight of the additional water reducible film-forming polymer and the graft copolymer into the coating.

As used herein, the term “film-forming polymer” means that the polymer can form a continuous film upon evaporation of all solvent or carrier and/or upon cure of the polymer. As used herein, the term “water reducible” is meant to include all polymers which can be stabily dispersed in water and is intended to include water-soluble polymers, dispersions, emulsions, and latices wherein the volatile content is, or can be, predominantly water.

Water-reducible film-forming polymers are well known in the art and can be prepared by any of the methods known in the art. Water-reducible polymers include those materials with sufficient hydrophilic and/or ionic groups (such as acid or amine groups) on the polymer to provide water solubility.

One common approach to producing water-soluble polymers is by the condensation reaction of reactants having a stoichiometric excess of ionic groups, such as acid groups which can subsequently be neutralized to provide water solubility. Water-reducible polyesters, polyureas, polyurethanes and other polymers can be prepared in this manner.

For example, the condensation polymerization reaction of reactants having a stoichiometric excess of acid or anhydride groups with reactants having hydroxyl, amine and/or epoxy functionality can produce acid functional polymers which can be neutralized with a base, such as an amine to provide water solubility.

Another method well known in the art to produce water-reducible polymers is by the free radical polymerization of unsaturated groups having acid functionality such as acrylic acid, methacrylic acid, or others, with other unsaturated monomers followed by neutralization of the ionic groups to provide water solubility.

Many other methods for producing water-reducible polymers are also known in the art. Representative commercially available water-soluble resins include Kelsol DV-5862, a water-reducible alkyd from Reichhold Chemicals and Rezimac WR 73-7331, a water-reducible epoxy resin from Eastman Chemical (formerly McWhorter Chemical). Other water-reducible film-forming polymers include the latex resins. Representative examples include styrene butadiene latices, polyvinyl acetate latices, acrylic latices, and many others. These types of polymers are frequently prepared by emulsion polymerization wherein the reactive monomers and appropriate initiators are emulsified in water in the presence of emulsifying agents to provide a stable dispersion of polymer particles in water. For some applications of this invention, it is especially useful to utilize latex resins which are more hydrophobic. These types of latices are representatively prepared by utilizing monomers that are more hydrophobic, and by using surfactants or emulsifying agents which are less water sensitive or which can be incorporated directly into the latex polymer itself.

Representative examples of some latices useful in the practice of this invention include the latex polymers taught in PCT application PCT/US99/23428 (WO 00/22016), entitled Latex Polymer Compositions; and U.S. Pat. No. 5,739,196. Representative commercially available latex resins useful in the practice of this invention include Rhoplex® Multilobe 200 (acrylic latex), Optive® 130 from BASF, Rhoplex® AC-264 (acrylic latex) both from Rohm and Haas Company, and Neocar® 2300 (vinyl versatate based latex), UCAR® 651 (acrylic copolymer), Ultracryl® 701 (acrylic latex), Neocar® 820 (acrylic latex), and Neocar® 7657 and 7658 (hydrophobic acrylic latices) all available from Union Carbide Corporation.

Other representative examples of water-reducible polymers optionally useful in combination with the graft copolymers of this invention include water-reducible acrylic modified polyesters such as taught in U.S. Pat. No. 4,735,995; acid-functional air drying polyurethanes such as taught in U.S. Pat. No. 5,104,737, and polyurethane dispersions such as taught in U.S. Pat. Nos. 5,310,780 and 5,912,299. For some applications the paint compositions of this invention can optionally incorporate a crosslinking agent reactive with any functional groups pendent on the graft copolymer. For example, if the graft copolymer incorporates pendent hydroxyl groups, crosslinkers such as ureas, melamines, or isocyanates could be utilized. Graft copolymers having pendent acid groups could be used in combination with polyepoxides as crosslinkers. Graft copolymers incorporating diacetone acrylamide could be crosslinked with reactive materials such as adipic dihydrazide. If crosslinkers are incorporated, catalysts for the curing reaction may also be incorporated as is well known in the art. For some crosslinking reactions, such as melamine/hydroxyl reactions, it is typically necessary to cure the coating at elevated temperatures ranging up to about 400° F.

The water-reducible coating compositions of this invention may also incorporate at least one pigment. Representative pigments include, for example, titanium dioxide, carbon black, graphite, ceramic black, lamp black, antimony sulfide, black iron oxide, aluminum pastes, yellow iron oxide, red iron oxide, iron blue, phthalo blue and green, nickel titanate, dianisidine orange, dinitroaniline orange, imidazole orange, quinacridone red, violet and magenta, toluidine red, molybdate orange, and the like. Extender pigments, such as amorphous, diatomaceous, fumed, quartz and crystalline silica, clays, aluminum silicates, magnesium aluminum silicates. talc, mica, delaminated clays, calcium carbonates and silicates, gypsum, barium sulfate, calcium zinc molybdates, zinc oxide, phosphosilicates and borosilicates of calcium, barium and strontium, barium metaborate monohydrate, and the like can also be incorporated.

Suitable dispersants and surfactants for use in the coatings of this invention can comprise any of the dispersants and surfactants readily available to the coatings industry, including the anionic and nonionic surfactants, soya lecithin, alkyl ammonium salts of fatty acids, amine salts of alkyl aryl sulfonates, unsaturated organic acids, sulfonated castor oil, mixtures of high boiling point aromatic and ester solvents, sodium salts of aryl sulfonic acid, and the like.

Suitable rheology modifiers which optionally can be included in the coatings of this invention representatively include organoclays, fumed silica, dehydrated castor oil organic derivatives, English China Clay; polyamides, polyamide modified alkyds, alkylbenzene sulphonate derivatives, aluminum, calcium and zinc stearates, calcium soyate, associative thickeners and the like. Suitable solvents for coatings of this invention include solvents which are stabily miscible with the water based coatings and representatively include, alcohols, ethers, esters, glycol ethers, glycol ether esters, hydrocarbons, etc.

### Aerosol Paint Compositions

In those instances when it is desired to utilize the coating compositions of this invention as aerosol coating compositions, the aerosol paint composition can be conveniently prepared by combining the water reducible coating composition (described above) with, if desired, additional water and/or solvents, and then incorporating a propellant which can aerosolize the combination.

The propellant is a liquefiable gas having a vapor pressure sufficient to propel the aerosol paint composition from the container. In many cases, the propellant is selected from the group consisting of ethers, saturated hydrocarbons, hydrofluorocarbons (HFC), and mixtures thereof. Representative propellants include dimethyl ether (DME) and diethyl ether; methane, ethane, propane, n-butane, and isobutane; 1,1,1,2-tetrafluoroethane (HFC-134a), 1,1,1,2,3,3,3,-heptafluoropropane (HFC-227), difluoromethane (HFC-32), 1,1,1-trifluoroethane (HFC-143a), 1,1,2,2-tetrafluoroethane (HFC-134), and 1,1-difluoroethane (HFC-152a).

The amount of the propellant present in the aerosol paint composition is typically at least 10 weight percent and preferably from about 10 to about 40 weight percent, more preferably from about 15 to about 25 weight percent of the total weight of the aerosol paint composition. When the propellant is present in an amount of from about 15 to about 25 weight percent, an initial pressure of between about 40 pounds per square inch and 70 pounds per square inch is obtained in the container.

The amount of water present in the aerosol paint composition is typically at least 30 weight percent of the total weight of the aerosol paint composition. Preferably, the amount of water present in the aerosol paint composition is from about 30 to about 60 weight percent, more preferably from about 45 to about 55 weight percent of the total weight of the aerosol paint composition.

The amount of polymer resins present in the aerosol paint composition is typically at least 10 weight percent of the total weight of the aerosol paint composition. For many applications, the amount of polymer resins present in the aerosol paint composition is from about 10 to about 30 weight percent, more preferably from about 15 to about 25 weight percent of the total weight of the aerosol paint composition.

The present invention will be better understood by reference to the following examples which are provided for purposes of illustration only and are not to be construed as limiting the scope of the present invention. As used herein, unless otherwise indicated, “parts” are “parts by weight”, and average particle size was determined using a Malvern NANO-S Particle Size Analyzer.

### RESIN EXAMPLE 1

A reaction vessel equipped with a nitrogen purge, stirrer, and two raw material inlets was charged with 108.8 parts PnB Glycol Ether (propylene glycol mono-n-butyl ether manufactured by The Dow Chemical Company) and heated to 280° F. and purged with nitrogen. Two separate raw material mixtures, mixture A and mixture B, were prepared.

MIXTURE A

| Raw materials | Parts by Weight |
|---|---|
| methacrylic acid | 102.4 |
| methyl methacrylate | 190.0 |
| 2-ethyl hexyl acrylate | 355.5 |
| t-butyl peroxybenzoate | 22.6 |
| dodecyl mercaptan | 19.0 |

MIXTURE B

| Raw materials | Parts by Weight |
|---|---|
| styrene | 270.5 |
| chlorinated polyolefin¹ | 270.5 |

¹50% by weight chlorinated polyolefin in xylene - having 26-32 weight percent chlorine and a number average molecular weight of approximately 24,000, commercially available from Eastman Chemical Company as Eastman CPO 343.3.

The mixtures were simultaneously added to the reaction vessel at a rate of 3.8 parts per minute for mixture A and a rate of 3.0 parts per minute for mixture B over a three hour period. The reaction mixture was then held at the 280° F. temperature for one-half hour and then, for a two hour period, a mixture of 22.6 parts t-butyl peroxybenzoate and 37.6 parts PnB Glycol Ether was added at a rate of 0.5 parts per minute over a two ¹ 50% by weight chlorinated polyolefin in xylene—having 26-32 weight percent chlorine and a number average molecular weight of approximately 24,000, commercially available from Eastman Chemical Company as Eastman CPO 343.3. hour period. The reaction mixture was then held at the reaction temperature for 30 additional minutes and then allowed to cool to about 180-200° F. The polymer had an acid value of approximately 63.

One thousand parts of the above reaction product at about 180° F. was admixed with 1,198.6 parts deionized water and 59.3 parts triethyl amine with agitation in a Kady Mill to produce a water reducible resin having an NVM of 35.6%, a weight per gallon of 8.47 pounds, and a viscosity of approximately 23 centipoise when measured with a Brookfield viscometer using a number 3 spindle at 60 rpm

### PAINT EXAMPLE 1

A coating was prepared by admixing the following materials:

| Raw materials | Parts by Weight |
|---|---|
| Resin Example 1 | 1204.15 |
| defoamer¹ | 2.65 |
| water | 397.17 |
| benzisothiazolone | 0.42 |
| dispersant² | 21.47 |
| surfactant³ | 5.59 |
| defoamer¹ | 2.65 |
| titanium dioxide | 423.50 |
| talc | 110.00 |
| plasticizer⁴ | 36.12 |
| water | 17.25 |
| latex resin⁵ | 15.00 |
| water | 3.34 |
| triethyl amine 98.5% | 5.50 |

¹Byk 024 available from Byk-Chemie Co.
²Tamol 165-A available from Rohm and Haas
³Triton CF-10
⁴Benzoflex B-50 available from Velsicol Company
⁵Acrysol RM-2020 hydrophobically modified polyurethane thickener available from Rohm and Haas

This paint had a VOC of 157.43 grams per liter, a pH of 8.52, an ICI viscosity of 2.89 poise and Krebs-Stormer viscosity of 86. When applied by brush over polypropylene substrate it exhibited a 60° gloss of 81, an 85° gloss of 89.8 and excellent adhesion after seven days air dry at room temperature.

### RESIN EXAMPLE 2

A reaction vessel equipped as described in Resin Example 1 was charged with 117.5 parts PnB Glycol Ether and heated to 280° F. and purged with nitrogen. Two separate raw material mixtures, mixture A and mixture B, were prepared.

MIXTURE A

| Raw materials | Parts by weight |
|---|---|
| methacrylic acid | 110.6 |
| methyl methacrylate | 205.2 |
| 2-ethyl hexyl acrylate | 384.0 |
| t-butyl peroxybenzoate | 24.5 |
| dodecyl mercaptan | 10.3 |

MIXTURE B

| Raw materials | Parts by weight |
|---|---|
| styrene | 292.2 |
| chlorinated polyolefin (CPO 343.3) | 73.1 |

The mixtures were simultaneously added to the reaction vessel at a rate of 4.5 parts per minute for Mixture A and 2.0 parts per minute for Mixture B over a three-hour period. The reaction mixture was then held at the 280° F. temperature for one-half hour and then, for a two hour period, a mixture of 24.5 parts t-butyl peroxybenzoate and 40.7 parts PnB was added at a rate of 0.55 parts per minute over a two hour period. The reaction mixture was then held at 280° F. for thirty additional minutes and then allowed to cool. The copolymer had an acid value of approximately 63.

Two hundred fifty parts of the above reaction product was admixed with a blend of 337.4 parts deionized water and 18.1 parts triethyl amine which had been heated to 180° F. in a Kady Mill to form a stable dispersion with an average particle size of 97 nanometers an NVM of 36.3%, a viscosity of 70 cps as measured with a Brookfield viscometer using a #3 spindle at 60 rpm at 25° C., a pH of 8.4, a weight per gallon of 8.54 pounds and a calculated VOC of 141.6 grams/liter.

A similar dispersion was made by combining 400 parts of the above reaction mixture, 539.8 parts deionized water, and 29.0 parts triethyl amine in a Kady Mill to produce a stable dispersion having an average particle size of 108 nanometers, an NVM of 36.90% a pH of 8.4, a viscosity of 40 centipoise and a weight per gallon of 8.55 and a calculated VOC of 141.6 grams per liter.

### RESIN EXAMPLE 3

A reaction vessel equipped as described in Resin Example 1 was charged with 263.8 parts PnP Glycol Ether (propylene glycol n-propyl ether from Dow Chemical) and heated to 280° F. and purged with nitrogen. Two separate raw material mixtures, mixture A and mixture B, were prepared.

MIXTURE A

| Raw materials | Parts by weight |
|---|---|
| methacrylic acid | 248.2 |
| methyl methacrylate | 460.5 |
| 2-ethyl hexyl acrylate | 861.7 |
| t-butyl peroxybenzoate | 55.0 |
| dodecyl mercaptan | 23.1 |

MIXTURE B

| Raw materials | Parts by weight |
|---|---|
| styrene | 655.6 |
| chlorinated polyolefin (CPO 343.3) | 494.7 |

The mixtures were simultaneously added to the reaction vessel at a rate of 9.2 parts per minute for Mixture A and 6.3 parts per minute for Mixture B over a three-hour period. The reaction mixture was then held at the 280° F. temperature for one-half hour and then, for a two hour period, a mixture of 55.0 parts t-butyl peroxybenzoate and 91.3 parts PnB was added at a rate of 0.55 parts per minute over a two hour period. The reaction mixture was then held at 280° F. for thirty additional minutes and then allowed to cool.

Six hundred parts of the above reaction product was admixed with a blend of 712.3 parts deionized water and 40.3 parts triethyl amine in a Kady Mill to form a stable dispersion with an average particle size of approximately 137 nanometers, an NVM of 36.9%, a viscosity of 56 cps as measured with a Brookfield viscometer using a #3 spindle at 60 rpm at 25° C., a pH of 8.6, and a weight per gallon of 8.51 pounds.

### PAINT EXAMPLE 2

### Aerosol Water-Reducible Coating

A coating was prepared by admixing the following materials:

| Raw materials | Parts by Weight |
|---|---|
| Resin Example 3 | 536.73 |
| Defoamer (Byk 024) | 1.20 |
| water | 182.39 |
| benzisothiazolone | 0.20 |
| dispersant (Tamol 165-A) | 9.71 |
| surfactant (Triton CF-10) | 2.49 |
| defoamer (Byk 024) | 1.20 |
| titanium dioxide | 191.78 |
| talc | 49.81 |
| plasticizer (Benzoflex B-50) | 16.44 |
| water | 8.28 |
| (Acrysol RM-2020 thickener) | 6.77 |
| water | 4.33 |
| triethyl amine 98.5% | 2.49 |
| Acrysol RM-825⁶ | 5.98 |

⁶associative thickener available from Rohm and Haas

A representative aqueous aerosol coating could be prepared by charging an aerosol container with 46 parts of the above described coating, 11 parts deionized water, 5 parts isopropyl alcohol, 3 parts 2-butoxy ethanol, and 35 parts dimethyl ether.

### RESIN EXAMPLE 4

A reaction vessel equipped as described in Resin Example 1 was charged with 263.8 parts PnB Glycol Ether and heated to 280° F. and purged with nitrogen. Two separate raw material mixtures, mixture A and mixture B, were prepared.

MIXTURE A

| Raw materials | Parts by weight |
|---|---|
| methacrylic acid | 248.2 |
| methyl methacrylate | 460.5 |
| 2-ethyl hexyl acrylate | 861.7 |
| t-butyl peroxybenzoate | 55.0 |
| dodecyl mercaptan | 23.1 |

MIXTURE B

| Raw materials | Parts by weight |
|---|---|
| styrene | 655.6 |
| chlorinated polyolefin (CPO 343.3) | 440.4 |

The mixtures were simultaneously added to the reaction vessel at a rate of 9.2 parts per minute for Mixture A and 6.0 parts per minute for Mixture B over a three-hour period. The reaction mixture was then held at the 280° F. temperature for one-half hour and then, for a two hour period, a mixture of 55.0 parts t-butyl peroxybenzoate and 91.3 parts PnB was added at a rate of 1.2 parts per minute over a two hour period. The reaction mixture was then held at 280° F. for thirty additional minutes and then allowed to cool.

One thousand five hundred parts of the above reaction product was admixed with a blend of 1776.0 parts deionized water and 84.4 parts triethyl amine which had been heated to 180° F. in a Kady Mill to form a stable dispersion with an average particle size of about 180 nanometers an NVM of 37.4%, a viscosity of 52 cps as measured with a Brookfield viscometer using a #3 spindle at 60 rpm at 25° C., a pH of 8.4, a weight per gallon of 8.52 pounds and a calculated VOC of 206.3 grams/liter.

A useful coating composition could be prepared by admixing 25 parts of the stable dispersion described above, 1.89 parts of a latex polymer such as BASF Optive® 130, along with appropriate additives such as flow agents and defoamers.

While the invention has been shown and described with respect to particular embodiments thereof, those embodiments are for the purpose of illustration rather than limitation and other variations and modifications of the specific embodiments herein described will be apparent to those skilled in the art, all within the intended spirit and scope of the invention. Accordingly, the invention is not to be limited in scope and effect to the specific embodiments described herein, nor in any other way that is inconsistent with the extent to which the progress in the art has been advanced by the invention.

What is claimed is:

1. An aqueous polymer solution comprising:
(i) water;
(ii) an acid functional polymer comprising the reaction product of:
(a) from about 1 to about 19% by weight of at least one chlorinated polyolefin;
(b) from about 1 to about 20% by weight of an unsaturated acid or anhydride;
(c) from about 61 to about 98% by weight of at least one other unsaturated monomer copolymerizable with the unsaturated acid or anhydride;
wherein the percentages are based upon the total combined weight of the chlorinated polyolefin and all unsaturated monomers;
(iii) a neutralizing agent in an amount sufficient to provide a stable aqueous dispersion of the acid functional polymer in water.

2. The aqueous polymer solution of claim 1 wherein the acid functional polymer comprises the reaction product of:
(a) from about 1 to about 19% by weight of at least one chlorinated polyolefin;
(b) from about 1 to about 20% by weight of an unsaturated acid or anhydride;
(c) from 1 to about 40% styrene;
(d) from about 21 to about 97% by weight of at least one other unsaturated monomer copolymerizable with the unsaturated acid or anhydride;
wherein the percentages are based upon the total combined weight of the chlorinated polyolefin and all unsaturated monomers.

3. The aqueous polymer solution of claim 1 wherein the acid functional polymer has an acid value of at least about 20.

4. The aqueous polymer solution of claim 1 wherein the acid functional polymer has an acid value of at least about 40.

5. The aqueous polymer solution of claim 1 wherein the acid functional polymer has an acid value of at least about 60.

6. The aqueous polymer solution of claim 2 wherein the acid functional polymer has an acid value of at least about 20.

7. The aqueous polymer solution of claim 2 wherein the acid functional polymer has an acid value of at least about 40.

8. The aqueous polymer solution of claim 2 wherein the acid functional polymer has an acid value of at least about 60.

9. The aqueous polymer solution of claim 1 wherein the chlorinated polyolefin is present at a level of about 1 to about 10% based upon the total combined weight of the chlorinated polyolefin and all unsaturated monomers.

10. The aqueous polymer solution of claim 1 wherein the chlorinated polyolefin is present at a level of about 1 to about 6% based upon the total combined weight of the chlorinated polyolefin and all unsaturated monomers.

11. The aqueous polymer solution of claim 1 wherein the chlorinated polyolefin is present at a level of about 1 to about 4% based upon the total combined weight of the chlorinated polyolefin and all unsaturated monomers.

12. The aqueous polymer solution of claim 1 wherein the chlorinated polyolefin has a number average molecular weight less than about 50,000.

13. The aqueous polymer solution of claim 1 wherein the chlorinated polyolefin has a number average molecular weight less than about 30,000.

14. The aqueous polymer solution of claim 1 wherein the aqueous solution comprises an additional water reducible polymer.

15. The aqueous polymer solution of claim 14 wherein the additional water reducible polymer is selected from the group consisting of latexes, acrylics, polyesters, alkyds, and polyurethanes.

16. The aqueous polymer solution of claim 14 wherein the additional water reducible polymer is present at a level of about 1 to about 99% by weight of the combined weight of the graft copolymer and the additional polymer.

17. The aqueous polymer solution of claim 14 wherein the additional water reducible polymer is present at a level of about 10 to about 60% by weight of the combined weight of the graft copolymer and the additional polymer.

18. A water reducible coating composition comprising:
(i) at least one pigment
(ii) an acid functional polymer comprising the reaction product of:
(a) from about 1 to about 19% by weight of at least one chlorinated polyolefin;
(b) from about 1 to about 20% by weight of an unsaturated acid or anhydride;
(c) from about 61 to about 98% by weight of at least one other unsaturated monomer copolymerizable with the unsaturated acid or anhydride;
wherein the percentages are based upon the total combined weight of the chlorinated polyolefin and all unsaturated monomers;
(iii) a neutralizing agent in an amount sufficient to provide a stable aqueous dispersion of the acid functional polymer in water;
(iv) water.

19. The coating composition of claim 18 wherein the coating also comprises at least one organic solvent.

20. The coating composition of claim 19 wherein the organic solvent is present at a level to provide a VOC of less than 150 grams per liter at a viscosity of 90 KU.

21. The coating of claim 18 wherein the coating also comprises at least one additional water reducible polymer.

22. The coating of claim 21 wherein the water reducible polymer is a latex resin.

23. The coating of claim 21 wherein the water reducible polymer is an alkyd resin.

24. The coating of claim 18 wherein the acid functional polymer has an acid value of at least 20.

25. The coating of claim 18 wherein the coating comprises a crosslinking agent reactive with the acid functional polymer.

26. A substrate coated with the coating of claim 18.

27. The coated substrate of claim 26 wherein the substrate is a plastic.

28. An aerosol paint product comprising:
(i) a container comprising a can, a valve cup with a valve assembly, a dip tube and an actuator; and
(ii) an aerosol paint composition disposed within said container, said aerosol paint composition comprising:
(a) at least 30 weight percent water;
(b) at least 10 weight percent of a water reducible coating composition;
(c) at least 10 weight percent of an aerosol propellant;
wherein the water reducible coating composition comprises:
(i) an acid functional polymer comprising the reaction product of:
(a) from about 1 to about 19% by weight of at least one chlorinated polyolefin;
(b) from about 1 to about 20% by weight of an unsaturated acid or anhydride;
(c) from about 61 to about 98% by weight of at least one other unsaturated monomer copolymerizable with the unsaturated acid or anhydride;
wherein the percentages are based upon the total combined weight of the chlorinated polyolefin and all unsaturated monomers; and
(ii) a neutralizing agent in an amount sufficient to provide a stable aqueous dispersion of the acid functional polymer in water.

29. The aerosol paint product of claim 28 wherein the water reducible coating composition also comprises at least one pigment.

30. The aerosol paint product of claim 28 wherein the propellant comprises dimethyl ether.

31. The aerosol paint product of claim 28 wherein the acid functional polymer comprises the reaction product of:
(a) from about 1 to about 19% by weight of at least one chlorinated polyolefin;
(b) from about 1 to about 20% by weight of an unsaturated acid or anhydride;
(c) from 1 to about 40% styrene;
(d) from about 21 to about 97% by weight of at least one other unsaturated monomer copolymerizable with the unsaturated acid or anhydride;
wherein the percentages are based upon the total combined weight of the chlorinated polyolefin and all unsaturated monomers.

32. A process of coating a substrate, which process comprises:
(i) providing an aerosol paint product comprising:
(a) a container comprising a can, a valve cup with a valve assembly, a dip tube and an actuator; and
(b) an aerosol paint composition disposed within said container, said aerosol paint composition comprising:
at least 30 weight percent water;
at least 10 weight percent of a water reducible coating composition;
at least 10 weight percent of an aerosol propellant;
(ii) activating the valve assembly to create an aerosol spray of the aerosol paint composition;
(iii) directing the spray to apply the paint composition onto the substrate; and
(iv) allowing the paint composition to sure or dry;
and wherein the water reducible coating composition comprises:
(i) an acid functional polymer comprising the reaction product of:
(a) from about 1 to about 19% by weight of at least one chlorinated polyolefin;
(b) from about 1 to about 20% by weight of an unsaturated acid or anhydride;
(c) from about 61 to about 98% by weight of at least one other unsaturated monomer copolymerizable with the unsaturated acid or anhydride;
wherein the percentages are based upon the total combined weight of the chlorinated polyolefin and all unsaturated monomers; and
(ii) a neutralizing agent in an amount sufficient to provide a stable aqueous dispersion of the acid functional polymer in water.

33. The process of claim 32 wherein the substrate is plastic.
